(19) United States
(12) Patent Application Publication
(10) Pub. No.: US 2023/0048487 A1
(43) Pub. Date: Feb. 16, 2023

(54) Zeolite composition suitable for tanning leather

(71) Applicant: Smit Tanning B.V., Weesp (NL)

(72) Inventors: Wouter Egbert-Jan Hendriksen, Weesp (NL); Dirick Jobst Alexander von Behr, Weesp (NL); Pim Jan-Willem Wilgenburg, Weesp (NL)

(73) Assignee: Smit Tanning B.V., Weesp (NL)

(21) Appl. No.: 17/784,131

(22) PCT Filed: Dec. 10, 2020
(86) PCT No.: PCT/NL2020/050773

§ 371 Date: Jun. 10, 2022

(30) Foreign Application Priority Data
Dec. 13, 2019 (NL) 2024455

(51) Int. Cl. C14C 3/04

(52) U.S. Cl. CPC C14C 3/04

(57) ABSTRACT

The invention relates to tanning agents for leather and concerns a zeolite composition suitable as a single tanning agent comprising zeolite, a first weak acid, a second weak acid and optionally a third weak acid. This zeolite composition enables an efficient and effective chrome-free tanning.

### FIELD OF THE INVENTION

The present invention relates to the field of leather manufacturing and single tanning agents comprising zeolite.

### BACKGROUND OF THE INVENTION

The production of leather concerns converting perishable skins or pelts into durable leather. To do so pre-treated hides are tanned with a tanning agent. Several tanning agents are known in the art. Typically three groups of tanning agents are identified; synthetic tanning agents, metal salt tanning agents and vegetable tanning agents.

Synthetic tanning agents or syntans are in general reactive aldehydes, however also phenol based condensate polymers are used as synthetic tanning agent. To reach the high quality standards for leather, typically combinations of reactive aldehydes and phenol based condensate polymers are used to tan leathers. Their application is limited to a limited number of leather article types. Furthermore, the aldehyde synthetic tanning agents are unhealthy for humans and therefore require special attention in the industrial tanning process, moreover the tanning waste water coming from the tanning process may be contaminated with the synthetic tanning agent.

Metal salt tanning agents are also known in the art as mineral tanning agents or tanning salts and comprise cations which have a valence of three or more such as chromium, aluminum, zirconium, titanium and iron. Such cations may interact with the collagen of the leather. Chromium tanning is by far the most dominant way of tanning as it gives excellent tanning results, but has widely recognized drawbacks related to the environmental impact of chromium both in relation to the waste coming from the tanning process as the leather comprising chromium. Also chromium tanning gives a blue appearance to the leather. Tanning with alternative tanning salts such as aluminum salts (mostly aluminum sulfate or alum) results in leather with poor water resistance; moreover the leather obtained is affected by solubilization of aluminum as the fixation of aluminum is less strong compared to chromium. Therefore in the art aluminum tanned leather is considered as incomplete tanned. Further metal salt alternatives such as tanning with iron is hampered by off-color and limitations in the after treatment of the leathers. Zirconium and titanium have both a valence of 4 (IV) and their application in tanning is limited. Penetration of cations with a valence of 4 implies a much lower penetration rate into the skin, moreover these cations cannot reach full saturation of the carboxyl groups, obtaining a leather with greater rigidity than a chrome tanned leather. Other problems for tanning with cation (IV) salts are the limited leather application types and economical availability of the materials.

Vegetable tanning agents are derived from plants such as oak and spruce bark. The tanning agents in these plants are polyphenols. Vegetable tanning is time consuming as a considerable amount of the vegetable tanning agent needs to be taken up in the leather. Furthermore, the limited options for colors are hindering economical usage in a wide range of leather articles.

As the conventional tanning methods have drawbacks with regard to process efficiency, human health, environmental impact or leather performance, new methods and tanning materials have been investigated such as zeolite tanning which is based on an aluminum silicate tanning agent.

WO 2013/114414 A1 describes a tanning method in which zeolite is combined with neutralizing agents and tanning materials for tanning leather. The examples demonstrate a combination with synthetic tanning agents for full tanning. The water usage is of this method is high and undesired resting of the tanned skin after tanning is needed.

WO 2013/045764 A1 describes a method in which zeolite is combined with a monocarboxylic acid and used as tanning agent. The water usage of the method is high. The zeolite monocarboxylic acid combination may be further combined with co-tanning agents such as aluminum sulfate and polycarboxylic acid. The tanning agent is preferably used in a two-step tanning process.

### SUMMARY OF THE INVENTION

There is a continuous need for a robust and efficient tanning agent that is environmentally friendly and not harmful (toxic) for humans. Moreover there is a need for a robust and efficient tanning agent that is easy to tailor towards different leather properties and leather applications. Also there is a need for a tanning agent that is safe in application and for which the starting materials are abundant.

Even though the shrinkage temperature is increased, the zeolite compositions of the art are insufficient as tanning agent as their penetration upon tanning is not acceptable, their uptake is poor and/or the leather quality of the produced leather is unsuitable for commercial exploitation. Moreover the leather production on commercial scale is not robust as too much fluctuation of leather quality occurs. Also the water usage when employing these tanning agents is high. The conventional remedy of adding additional tanning agents to the zeolite composition such as tanning salts, synthetic tanning agents or vegetable tanning agents either do not improve the tanning result and efficiency or bring along the known disadvantages of such tanning agents.

The inventors now surprisingly found that the above described needs could be met with a zeolite composition suitable as single tanning agent comprising zeolite, a first weak acid, a second weak acid and optionally a third weak acid wherein the first, the second and the third weak acid are different acids. This zeolite composition was found to be effective for tanning without the need for further tanning agents such as synthetic tanning agents, metal salt tanning agents and vegetable tanning agents. The zeolite composition of the invention is easy to implement in conventional tanning processes as it can be applied in one step and the tanning time is similar to conventional industry standard tanning processes.

The inventors found that a zeolite composition comprising one weak acid, when employed in a one-step tanning process, gave insufficient penetration of the leather and leather organoleptic properties that are not acceptable, regardless of that the leather obtained has a sufficient shrinkage temperature (example 1). When scaling up to industrial scale leather tanning the insufficient penetration is even more clearly observed. Insufficient penetration results in leather that has an uneven surface (look, physical and chemical properties vary over the surface) and that is not suitable for splitting. Also the uptake was found to be poor which results in an inefficient use of the zeolite composition and waste water that comprises a considerable amount of the zeolite composition.

Surprisingly, only when the zeolite composition comprises two specific weak acids (example 2) or any combination of three weak acids (example 3) sufficient penetration is effectuated, and leather quality and uptake are good. Specifically, already with two specific weak acids sufficient uptake is realized. Moreover, the inventors surprisingly found that excellent tanning results can be obtained in the absence of metal tanning salts such as aluminum sulfate. Aluminum sulfate is a weak multivalent inorganic acid salt comprising a cation and the cation is aluminum. The inventors surprisingly realized that such tanning salts are contra-productive. As a consequence of that metal tanning salts such as aluminum sulfate create a cationic surface charge to the collagen of the leather and that zeolite creates an anionic surface charge, metal tanning salts such as aluminum sulfate interfere with zeolite which will result in less efficient tanning. As a consequence penetration, shrinkage temperature, leather properties and/or uptake will worsen. This may lead to a higher levels of undesired aluminum in the tanning waste streams and an inefficient use of the zeolite composition as a larger part of the composition goes to waste (example 4).

The inventors surprisingly found for a zeolite composition to be suitable as a tanning agent, there need to be several weak acids present to provide all the required interactions for effective and efficient tanning. The different interactions that are required relate to the dispersion of the zeolite into water, to the interaction between zeolite and collagen and in some cases to the need for pH stabilization. Multiple acids are needed for the different required interactions; one acid aid in the dispersion of the zeolite into the water, another acid aid in the interaction between the zeolite and the collagen of the hides, and another acid may further support these interactions and/or support in the pH stabilization. Each type of acid has its specific interactions with either the zeolite and/or the collagen of the hide which are specifically observable in the leather properties.

The zeolite composition of the invention enables tailoring leather properties such as the leather feel and the shrinkage temperature of the leather whilst keeping good penetration; the tailoring can be effectuated by choosing specific combinations of weak acids. The leather obtained by tanning with the zeolite composition of the invention has excellent solubilization, also referred to as washout, properties and the tanning process with the zeolite composition of the invention has a good tanning uptake, also named uptake. Tanning uptake in general is the ratio of the amount of tanning agent that is taken up by the leather upon tanning divided by the amount of tanning agent provided during the tanning step. For tanning with the zeolite composition of the invention as a single tanning agent the tanning uptake is the amount of aluminum taken up by the leather upon tanning divided by the amount of aluminum that is present in the zeolite composition that is provided during the tanning step. Tanning uptake is expressed in percentage.

Furthermore the leather obtained by tanning with the zeolite composition of the invention has a white appearance and does not give an off-color, such as wet-blue leather obtained by chrome tanning and wet-white leather. Therefore there is more freedom to color the leather and brilliant colors can be applied.

The zeolite composition of the invention can be integrated in conventional tanning processes without the need for adaptations. The zeolite composition can be used as a single tanning agent without the use of further tanning agents. Moreover there is no need for a two-step tanning process; the zeolite composition is effective in a single tanning step. A single tanning step is more efficient as the tanning agent only needs to be added once and the tanning time is shorter. On top of this, in most cases the combined amount of tanning agent in a two-step process is higher than the amount needed for a one-step process.

The invention concerns a zeolite composition suitable as single tanning agent, a method for preparing the zeolite composition, the zeolite composition obtained by the method for preparing, a method for producing leather wherein a hide is contacted with a tanning composition comprising the zeolite composition and the leather obtained by the method for producing leather.

### FIGURES

FIG. 1A: Distribution of aluminum over the perpendicular cross section of the piece of leather obtained from example 5 determined by SEM-EDX. X-axis: length-scale across the perpendicular cross section (micrometer); left side is flesh side, right side grain side. Y-axis: intensity. The upper dashed line is the concentration at the surface, the lower dashed line is the concentration at the center of the perpendicular cross section of the piece of leather.

FIG. 1B: Distribution of silicon over the perpendicular cross section of the piece of leather obtained from example 5 determined by SEM-EDX. X-axis: length-scale across the perpendicular cross section (micrometer); left side is flesh side, right side grain side. Y-axis: intensity. The upper dashed line is the concentration at the surface, the lower dashed line is the concentration at the center of the perpendicular cross section of the piece of leather.

### DETAILED DESCRIPTION OF THE INVENTION

In a first embodiment the invention concerns a zeolite composition suitable as single tanning agent comprising zeolite, a first weak acid, a second weak acid and optionally a third weak acid wherein the first, the second and the third weak acid are different acids, the amount of zeolite is at least 34 wt. %, preferably at least 50 wt. % based on total weight of the zeolite composition and the amount of water is less than 25 wt. %, preferably less than 20 wt. % based on total weight of the zeolite composition.

Furthermore the invention concerns a method for preparing the zeolite composition, comprising
a) in case the first weak acid, the second weak acid and the third weak acid, when present, are solid at 20° C.
   i) mixing the first weak acid, the second weak acid, the zeolite and the third weak acid, when present, while keeping the temperature of the mixture during mixing below 100° C.;
or
b) in case any one of the first weak acid, the second weak acid or the third weak acid, when present, is liquid at 20° C.
   ii) mixing the weak acid which is liquid at 20° C., or the weak acids which are liquid at 20° C. with the zeolite while keeping the temperature of the mixture during mixing below 100° C., and
   iii) mixing any remnant weak acid or remnant weak acids with the mixture obtained in step ii) while keeping the temperature of the mixture during mixing below 100° C.

The invention also concerns a zeolite composition suitable as single tanning agent obtained by this method.

Also the invention concerns a method for producing leather, comprising a tanning step wherein a hide is contacted with a tanning liquid comprising the zeolite composition and the concentration of the zeolite composition is in the range from 1 wt. % to 15 wt. % based on weight of the hide.

The invention further concerns leather having
a shrinkage temperature of above 60° C., preferably of above 70° C., and
an iso-electric point in the range from 3 to 5, preferably in the range from 3.5 and 4.5, and comprising more than 0.5 wt. % aluminum based on dry weight of the leather and more than 0.5 wt. % silicon based on dry weight of the leather.

The invention further comprises the use of the zeolite composition of the invention for improving tanning uptake, wherein the zeolite composition is a single tanning agent.

Also comprises the invention the use of the zeolite composition of the invention for improving leather penetration, wherein the zeolite composition is a single tanning agent.

Zeolite

The zeolite composition comprises zeolite. Zeolites are also referred to aluminosilicates. Zeolite as known in the art is a mineral having a crystalline structure and may be characterized by the size of its pores, the chemical composition and/or the crystalline structure. For the current invention preferably the zeolite is a zeolite having the general formula (Cat_{2/n}O)_{X} (Al₂O₃) (SiO₂)_{Y} wherein Cat is a cation, O is oxygen, Si is silicon, and Al is aluminum. In a preferred embodiment when the cation is monovalent n=1, X is between 0.5 and 1.8, Y is between 0.8 and 40 and H₂O is present as crystal water or when the cation is divalent n=2, X is between 0.5 and 1.8, Y is between 0.8 and 40 and crystal water is present; more preferably the cation is monovalent and n=1, X is between 0.5 and 1.8, Y is between 0.8 and 14 and crystal water is present; most preferably the cation is sodium (Na) and X is between 0.5 and 1.8, Y is between 0.8 and 14 and crystal water is present. Preferably the Al₂O₃ weight percentage is in the range from 25 wt. % to 40 wt. % based on total weight of the zeolite and the SiO_{2weight} percentage is in the range from 28 wt. % to 40 wt. % based on total weight of the zeolite. Preferably the pore size of the zeolite is 3 Ångstrom or larger even more preferably 4 Ångstrom or larger, most preferably 5 Ångstrom or larger. Ångstrom (Å) is a unit of length and is equal to 10⁻¹⁰ meter. A larger pore size improves the interaction between zeolite and the weak acid. Preferably the zeolite is an A, Y, X, or P type of zeolite, more preferably the zeolite is an A type zeolite. Preferably the zeolite has a loss on ignition content of less than 40 wt. %, more preferably less than 25 wt. %, even more preferably less than 15 wt. %. Loss on ignition is known in the art and can be measured, measuring the initial weight, heating the zeolite to 800° C. and measuring the weight decrease until the weight becomes stable. The loss on ignition is the difference of the initial weight and the stable weight after heating divided by the initial weight, expressed in weight percentage. A low loss on ignition equals a low water content and thus a more concentrated product which is easier to use under production circumstances. Typically the zeolite of the invention has a water content before being contacted with a weak acid, so the zeolite has a water content. This water content is typically in the range from 1 wt. % to 25 wt. % of the total weight of the zeolite.

Acid

The zeolite composition of the invention comprises a first weak acid, a second weak acid and optionally a third weak acid. A weak acid is known in the art and concerns an acid which when dissolved in water does not fully dissociate in a proton (H⁺) and an anion. A weak acid has an acid dissociation constant (pKa) value, higher than −1.74.

Weak acids can be classified in organic acids, salts of organic acids, weak inorganic acids and a weak inorganic acid salts. A weak acid salt comprises a cation and an anion. Preferably the cation of the weak acid salts, both organic and inorganic, of the zeolite composition of the invention is a monovalent or divalent cation, more preferably the cation is selected from the group consisting of sodium, potassium, ammonium, calcium and magnesium, even more preferably the cation is sodium or potassium, most preferably the cation is sodium.

Other cations are undesirable as being environmentally unfriendly, being harmful to humans, being expensive, giving poor dissolution properties of the zeolite composition, giving discoloration of the leather and/or affecting the effectiveness of the zeolite composition for tanning. For example, chromium is environmental unfriendly, harmful to humans and gives a blue color to the leather. Iron discolors the leather whilst aluminum salts are known for their poor solubilization results, meaning that the leather upon use loses aluminum which leads to poor leather properties. Furthermore, aluminum salts bind less effective with the collagen compared to the zeolite composition, leading to an undesirable higher aluminum concentration in the effluent and lower yield.

Moreover, as the tanning effect of the zeolite composition is a resultant of the combination of weak acids and zeolite there is no need for other tanning salts with a cation that has tanning properties, such as chromium, aluminum, titanium, zirconium or iron salts. Even worse, taking up such tanning salts in the zeolite composition will be counterproductive. Tanning salts interfere with the zeolite; the zeolite interacts with collagen through an Van der Waals association of the zeolite leading to an low isoelectric point of the zeolite containing leathers, whilst tanning salts interact with collagen through a cationic association leading to a high isoelectric point of the tanning salts containing leathers. Because of this interference the zeolite composition becomes less effective for tanning. The effects of the interaction are reflected in the isoelectric point as measured with zeta-potential that is above 6.5 (pl value) for tanning salt tanned leather and between 3 and 5 for leather tanned according to the invention.

Preferably the first weak acid, the second weak acid and the third weak acid, when present, are selected from the group consisting of an organic acid, a salt of an organic acid comprising a cation, a weak inorganic acid and a weak inorganic acid salt comprising a cation; wherein the cation is selected from the group consisting of sodium, potassium, ammonium, calcium and magnesium, preferably the cation is sodium or potassium, most preferably the cation is sodium.

Preferably the third weak acid is present.

Preferably the organic acid is selected from the group consisting of carboxylic acids and organic sulfonic acids, more preferably the organic acid is selected from the group consisting of carboxylic acids and aromatic-sulfonic acids, even more preferably the organic acid is selected from the group consisting of carboxylic acids, phenolsulfonic acids, naphthalene-sulfonic acids and sulfanilic acid, most preferably the organic acid is a carboxylic acid.

A carboxylic acid is a monocarboxylic acid or a polycarboxylic acid. A monocarboxylic acid has one carboxylic group per molecule, a polycarboxylic acid comprises more than one carboxylic group per molecule, a dicarboxylic acid has two carboxylic groups per molecule, a tricarboxylic acid has three carboxylic groups per molecule a tetracarboxylic acid has four carboxylic groups per molecule. Preferably for this invention, when the organic acid is a carboxylic acid, the organic acid is a monocarboxylic acid, or oppositely, preferably for this invention, when the organic acid is a carboxylic acid, the organic acid is a polycarboxylic acid, more preferably, when the organic acid is a carboxylic acid, the organic acid is a dicarboxylic acid or a tricarboxylic acid, even more preferably a dicarboxylic acid. Or alternatively, when the organic acid is a carboxylic acid, preferably the organic acid is a monocarboxylic acid or a dicarboxylic acid.

Preferably the organic acid is selected from the group consisting of formic acid, acetic acid, propionic acid, butyric acid, benzoic acid, butenoic acid, pentanoic acid, adipic acid, citric acid, oxalic acid, galactaric acid, gallic acid, gluconic acid, glucuronic acid, glycolic acid, lactic acid, nicotinic acid, ascorbic acid, malonic acid, maleic acid, succinic acid, glutaric acid, tartaric acid, phatalic acid, salicylic acid, 4-phenolsulfonic acid, naphthalene-1-sulfonic acid, naphthalene-2-sulfonic acid, sulfanilic acid, succinic acid, more preferably the organic acid is selected from the group consisting of formic acid, acetic acid, propionic acid, butyric acid, butenoic acid, pentanoic acid, adipic acid, citric acid, oxalic acid, galactaric acid, gallic acid, gluconic acid, glucuronic acid, glycolic acid, lactic acid, nicotinic acid, ascorbic acid, malonic acid, maleic acid, succinic acid, glutaric acid, tartaric acid, phatalic acid, naphthalene-2-sulfonic acid, sulfanilic acid, even more preferably the organic acid is selected from the group consisting of formic acid, gallic acid, oxalic acid, citric acid and tartaric acid, most preferably the organic acid is selected from the group consisting of formic acid, gallic acid, oxalic acid and tartaric acid.

Preferably the salt of an organic acid comprising a cation is selected from the group consisting of cation carboxylic acid salts and cation organic sulfonates, more preferably the salt of an organic acid comprising a cation is selected from the group consisting of cation carboxylic acid salts, cation phenolsulfonic acid salts, cation naphthalene-sulfonic acid salts and cation sulfanilic acid salt, wherein the cation is selected from the group consisting of sodium, potassium, ammonium, calcium and magnesium. Even more preferably the salt of an organic acid comprising a cation is selected from the group consisting of sodium formate, sodium acetate, sodium oxalate and sodium naphthalene sulfonate, more preferably the salt of an organic acid comprising a cation is selected from the group consisting of sodium formate, sodium oxalate and sodium acetate.

Preferably the weak inorganic acid salt comprising a cation is selected from the group consisting of cation sulfates, cation bisulfates, cation hydrogen sulfates, wherein the cation is selected from the group consisting of sodium, potassium, ammonium, calcium and magnesium, preferably wherein the cation is selected from the group consisting of sodium and potassium. Preferably the weak inorganic acid salt comprising a cation is sodium bisulfate.

Preferably the weak inorganic acid is boric acid, phosphoric acid, silicic acid or aminosulfonic acid.

Preferably one or more of the first weak acid, the second weak acid and the third weak acid, when present, is an organic acid comprising a molecular diameter of less than 20 Å, preferably less then 12 Å, more preferably less then 8 Å, most preferably less then 4 Å; more preferably the first weak acid, is an organic acid comprising a molecular diameter of less than 20 Å, preferably less then 12 Å, more preferably less then 8 Å, most preferably less than 4 Å.

The molecular diameter, also known as kinetic diameter or critical diameter, is the smallest diameter of a molecule for entering a pore. Not bound by theory it is believed small molecules are able to beneficially interact with the zeolite. The pore size of the zeolite structure allows penetration of the smaller organic acids into the structure. As such, the molecular size of the acids in relation to the pore size of the zeolite structures aids in the penetration. The penetrated small molecule acids are able to beneficially interact with the zeolite and allow for better dispersion into the liquid phase during application.

In one embodiment the first weak acid, the second weak acid and the third weak acid, when present, is selected from the group consisting of sodium di-formate, Sodium diacetate, sulfanilic acid, 2-Aminopentanedioic acid, 2-Oxopropanoic acid, 2-Hydroxyethanoic acid and 3-Oxobutanoic acid, preferably is selected from the group consisting of Sodium diacetate, sulfanilic acid, 2-Aminopentanedioic acid, 2-Oxopropanoic acid, 2-Hydroxyethanoic acid and 3-Oxobutanoic acid.

In another preferred embodiment the first weak acid is an organic acid and the second weak acid and the third weak acid, when present, is an organic acid, a weak inorganic acid salt comprising a cation, a weak inorganic acid or a weak inorganic acid salt comprising a cation; and wherein the cation is selected from the group consisting of sodium, potassium, ammonium, calcium and magnesium. More preferably:
the first weak acid is a carboxylic acid, most preferably a monocarboxylic acid or dicarboxylic acid,
the second weak acid is a carboxylic acid, preferably a dicarboxylic or tricarboxylic acid, and
the third weak acid is selected from the group consisting of cation sulfates, cation bisulfates, cation hydrogen sulfates and cation naphthalene sulfonates, wherein the cation is selected from the group consisting of sodium, potassium, ammonium, calcium and magnesium, more preferably the third weak acid is a cation naphthalene sulfonate or a cation bisulfate wherein the cation is selected from the group consisting of sodium, potassium, ammonium, calcium and magnesium, even more preferably the third weak acid is a cation bisulfate wherein the cation is selected from the group consisting of sodium, potassium, ammonium, calcium and magnesium.

A further embodiment of the invention concerns the zeolite composition, wherein
the second weak acid is a carboxylic acid, a cation organic sulfonate or a weak inorganic acid salt comprising a cation wherein the cation is selected from the group consisting of sodium, potassium, ammonium, calcium and magnesium, and
the third weak acid, when present, is a polycarboxylic acid, a cation organic sulfonate or a weak inorganic acid salt comprising a cation wherein the cation is selected from the group consisting of sodium, potassium, ammonium, calcium and magnesium.

In another preferred embodiment the first weak acid is a carboxylic acid, most preferably a monocarboxylic acid or dicarboxylic acid and the second weak acid and the third weak acid, when present, is an organic acid, a weak inorganic salt comprising a cation or a weak inorganic acid salt comprising a cation; and wherein the cation is selected from the group consisting of sodium, potassium, ammonium, calcium and magnesium, more preferably the second weak acid and the third weak acid, when present, is an organic acid or a weak inorganic acid salt comprising a cation; and wherein the cation is selected from the group consisting of sodium, potassium, ammonium, calcium and magnesium.

Even more preferably the second weak acid and the third weak acid, when present, is a carboxylic acid, a naphthalene-sulfonic acid, a phenolsulfonic acid, a cation carboxylic acid salt, a cation organic sulfonate, a cation naphthalene sulfonate, a cation sulfate, a cation bisulfate, a cation hydrogen sulfate, wherein the cation is selected from the group consisting of sodium, potassium, ammonium, calcium and magnesium. Even further preferably the second weak acid and the third weak acid, when present, is a carboxylic acid, a cation naphthalene sulfonate, a cation bisulfate wherein the cation is selected from the group consisting of sodium, potassium, ammonium, calcium and magnesium. In a particular preferred embodiment, the second weak acid and the third weak acid, when present, is a carboxylic acid, a cation naphthalene sulfonate, a cation bisulfate, wherein the cation is selected from the group consisting of sodium, potassium, ammonium, calcium and magnesium, most preferably the second weak acid and the third weak acid, when present, is a carboxylic acid or a cation bisulfate, wherein the cation is selected from the group consisting of sodium, potassium, ammonium, calcium and magnesium.

In another preferred embodiment the third weak acid is present. For this embodiment the first, second and third weak acid are selected from the group consisting of a carboxylic acid and a weak inorganic acid salt comprising a cation wherein the cation is selected from the group consisting of sodium, potassium, ammonium, calcium and magnesium. Preferably in this embodiment the first, second and third weak acid are selected from the group consisting of a monocarboxylic acid, a dicarboxylic acid, a tricarboxylic acid and a weak inorganic acid salt comprising a cation wherein the cation is selected from the group consisting of sodium, potassium, ammonium, calcium and magnesium. More preferably the first weak acid is a carboxylic acid, the second weak acid is a carboxylic acid and the third weak acid is a carboxylic acid or a weak inorganic acid salt comprising a cation wherein the cation is selected from the group consisting of sodium, potassium, ammonium, calcium and magnesium. Even more preferably the first weak acid is a monocarboxylic acid or dicarboxylic acid, the second weak acid is a monocarboxylic acid, a dicarboxylic acid or a tricarboxylic acid and the third weak acid is a monocarboxylic acid, a dicarboxylic acid or a weak inorganic acid salt comprising a cation wherein the cation is selected from the group consisting of sodium, potassium, ammonium, calcium and magnesium. Preferably for this embodiment the cation is sodium or potassium.

In a preferred embodiment the first weak acid is a carboxylic acid, preferably a monocarboxylic acid or dicarboxylic acid, the second weak acid is a carboxylic acid, preferably a monocarboxylic acid, a dicarboxylic acid or a tricarboxylic acid and the third weak acid is a dicarboxylic acid, a tricarboxylic acid or a weak inorganic acid salt comprising a cation wherein the cation is selected from the group consisting of sodium, potassium, ammonium, calcium and magnesium. More preferably the first weak acid is a monocarboxylic acid or dicarboxylic acid, the second weak acid is a monocarboxylic acid, a dicarboxylic acid or a tricarboxylic acid and the third weak acid is a dicarboxylic acid or a weak inorganic acid salt comprising a cation wherein the cation is selected from the group consisting of sodium, potassium, ammonium, calcium and magnesium.

Preferably the first weak acid, the second weak acid and the third weak acid, when present, is selected from the group consisting of formic acid, adipic acid, citric acid, sodium bisulfate, oxalic acid, phtalic acid, salicylic acid, succinic acid, tartaric acid and maleic acid. More preferably the first weak acid, the second weak acid and the third weak acid, when present, is selected from the group consisting of formic acid, oxalic acid, citric acid, galactaric acid, gallic acid, phtalic acid, succinic acid, tartaric acid and sodium bisulfate, most preferably from the group consisting of formic acid, gallic acid, oxalic acid, citric acid, tartaric acid and sodium bisulfate. Even more preferably the first weak acid is selected from the group consisting of formic acid, citric acid, oxalic acid, phtalic acid and succinic acid and the second weak acid and the third weak acid, when present, is selected from the group consisting of citric acid, sodiumbisulfate, galactaric acid, gallic acid, oxalic acid and tartaric acid; even more preferably the first weak acid is formic acid or oxalic acid and the second weak acid and the third weak acid, when present, is selected from the group consisting of citric acid, sodiumbisulfate, gallic acid, oxalic acid and tartaric acid.

A further embodiment of the invention concerns the zeolite composition, wherein the third weak acid is present and the first weak acid, the second weak acid and the third weak acid are selected from the group consisting of formic acid, citric acid, oxalic acid, tartaric acid, gallic acid and sodium bisulfate; preferably wherein the third weak acid is present and the first weak acid is selected from the group consisting of formic acid and oxalic acid and the second weak acid is selected from the group consisting of citric acid, tartaric acid, gallic acid and oxalic acid and the third weak acid is selected from the group consisting of sodium bisulfate, tartaric acid, gallic acid and oxalic acid.

In another preferred embodiment the first and the second weak acid are selected from the group consisting of a monocarboxylic acid, a dicarboxylic acid and a weak inorganic acid salt comprising a cation, wherein the cation is selected from the group consisting of sodium, potassium, ammonium, calcium and magnesium. More preferably the first weak acid is a monocarboxylic acid or a dicarboxylic acid and the second weak acid is selected from the group consisting of a monocarboxylic acid, a dicarboxylic acid and a weak inorganic acid salt comprising a cation, wherein the cation is selected from the group consisting of sodium, potassium, ammonium, calcium and magnesium. Even more preferably the first weak acid is a dicarboxylic acid and the second weak acid is selected from the group consisting of a monocarboxylic acid, a dicarboxylic acid and a weak inorganic acid salt comprising a cation, wherein the cation is selected from the group consisting of sodium, potassium, ammonium, calcium and magnesium. Most preferably the first weak acid is a dicarboxylic acid and the second weak acid is a weak inorganic acid salt comprising a cation, wherein the cation is selected from the group consisting of sodium, potassium, ammonium, calcium and magnesium. Preferably for this embodiment the cation is selected from the group consisting of sodium and potassium, more preferably for this embodiment the weak inorganic acid salt comprising a cation is sodium bisulfate. The combination of acids of this embodiments provides a zeolite composition that is suitable as a single tanning agent without the need of other tanning agents and has improved uptake compared to other acid combinations.

In one embodiment preferably the first weak acid and the second weak acid are selected from the group consisting of phtalic acid, succinic acid, formic acid, oxalic acid, tartaric acid, gallic acid and sodium bisulfate; more preferably wherein the first weak acid is selected from the group consisting of phtalic acid, succinic acid, formic acid, oxalic acid and sodium bisulfate and the second weak acid is selected from the group consisting of sodium bisulfate, tartaric acid, oxalic acid and gallic acid, even more preferably the first weak acid is selected from the group consisting of phthalic acid, succinic acid and oxalic acid and the second weak acid is selected from the group consisting of sodium bisulfate, tartaric acid, oxalic acid and gallic acid, most preferably the first weak acid is selected from the group consisting of phthalic acid, succinic acid and oxalic acid and the second weak acid is sodium bisulfate. The combination of acids of this embodiments provides a zeolite composition that is suitable as a single tanning agent without the need of other tanning agents and has improved uptake compared to other acid combinations.

In a preferred embodiment the first weak acid and the second weak acid are selected from the group consisting of formic acid, oxalic acid, tartaric acid, gallic acid and sodium bisulfate; preferably wherein the first weak acid is selected from the group consisting of formic acid, sodium bisulfate and oxalic acid and the second weak acid is selected from the group consisting of sodium bisulfate, tartaric acid, gallic acid and oxalic acid, more preferably the first weak acid is selected from the group consisting of formic acid and oxalic acid and the second weak acid is selected from the group consisting of sodium bisulfate, tartaric acid, gallic acid and oxalic acid. The combination of acids of this embodiments provides a zeolite composition that is suitable as a single tanning agent without the need of other tanning agents and has improved penetration and uptake compared to other acid combinations.

In a preferred embodiment the combination of the first weak acid and the second weak acid and the third weak acid, when present, is selected from the group consisting of the following combinations:— the first weak acid is formic acid and the second weak acid is tartaric acid,
the first weak acid is formic acid and the second weak acid is oxalic acid,
the first weak acid is oxalic acid and the second weak acid is sodium bisulfate,
the first weak acid is sodium bisulfate and the second weak acid is oxalic acid,
the first weak acid is formic acid and the second weak acid is sodium bisulfate,
the first weak acid is formic acid and the second weak acid is gallic acid,
the first weak acid is formic acid, the second weak acid is citric acid and the third weak acid is sodium bisulfate,
the first weak acid is formic acid, the second weak acid is tartaric acid and the third weak acid is sodium bisulfate,
the first weak acid is formic acid, the second weak acid is oxalic acid and the third weak acid is sodium bisulfate,
the first weak acid is formic acid, the second weak acid is citric acid and the third weak acid is oxalic acid,
the first weak acid is oxalic acid, the second weak acid is gallic acid and the third weak acid is tartaric acid,
the first weak acid is oxalic acid, the second weak acid is tartaric acid and the third weak acid is sodium bisulfate, and
the first weak acid is formic acid, the second weak acid is oxalic acid and the third weak acid is gallic acid.

More preferably, the combination of the first weak acid and the second weak acid and the third weak acid, when present, is selected from the group consisting of the following combinations:
the first weak acid is formic acid, the second weak acid is citric acid and the third weak acid is sodium bisulfate,
the first weak acid is formic acid, the second weak acid is tartaric acid and the third weak acid is sodium bisulfate,
the first weak acid is formic acid, the second weak acid is oxalic acid and the third weak acid is sodium bisulfate,
the first weak acid is formic acid, the second weak acid is citric acid and the third weak acid is oxalic acid,
the first weak acid is oxalic acid, the second weak acid is gallic acid and the third weak acid is tartaric acid,
the first weak acid is oxalic acid, the second weak acid is tartaric acid and the third weak acid is sodium bisulfate, and
the first weak acid is formic acid, the second weak acid is oxalic acid and the third weak acid is gallic acid.

Most preferably, the combination of the first weak acid and the second weak acid and the third weak acid, when present, consist of the combination:
the first weak acid is formic acid, the second weak acid is oxalic acid and the third weak acid is sodium bisulfate.

In a preferred embodiment the combination of the first weak acid and the second weak acid is selected from the group consisting of the following combinations:
the first weak acid is phtalic acid and the second weak acid is sodium bisulfate,
the first weak acid is succinic acid and the second weak acid is sodium bisulfate,
the first weak acid is formic acid and the second weak acid is tartaric acid,
the first weak acid is formic acid and the second weak acid is oxalic acid,
the first weak acid is oxalic acid and the second weak acid is sodium bisulfate,
the first weak acid is sodium bisulfate and the second weak acid is oxalic acid,
the first weak acid is formic acid and the second weak acid is sodium bisulfate,
the first weak acid is formic acid and the second weak acid is gallic acid,

In a more preferred embodiment the combination of the first weak acid and the second weak acid is selected from the group consisting of the following combinations:
the first weak acid is phtalic acid and the second weak acid is sodium bisulfate,
the first weak acid is succinic acid and the second weak acid is sodium bisulfate,
the first weak acid is oxalic acid and the second weak acid is sodium bisulfate.

The weak acid before mixing with the zeolite may comprise water. To keep the water content low of the zeolite composition, and to improve the effectiveness of the zeolite composition, preferably the weak acids are concentrated weak acids. Preferably the concentration of weak acid is at least 80 wt. % based on total weight of the weak acid, more preferably at least 90 wt. % based on total weight of the weak acid, even more preferably at least 95 wt. % based on total weight of the weak acid.

Preferably the first weak acid, the second weak acid and/or the third weak acid are solid at 20° C., more preferably the second weak acid and the third weak acid, when present, are solid at 20° C. In another embodiment preferably the first weak acid, the second weak acid and/or the third weak acid are liquid at 20° C., more preferably the first weak acid is liquid at 20° C. Preferably, in case one or more weak acids are liquid at 20° C., the ratio of total liquid weak acids to zeolite is such that after mixing the combination of liquid weak acids and zeolite form a solid mass, preferably a powder. Preferably the ratio of total liquid weak acids to zeolite is below 70 wt. %, more preferably below 55 wt. %, most preferably below 35 wt. %. The wt. % for these ratios is the weight of total liquid weak acid divided by weight of zeolite expressed in percentage.

Zeolite Composition

In the context of the invention a tanning agent is a leather tanning agent and tanning is leather tanning. The zeolite composition of the invention comprises water. Preferably the zeolite composition comprises less than 25 wt. % water based on total weight of the zeolite composition, more preferably less than 20 wt. % based on total weight of the zeolite composition, most preferably less than 15 wt. % water based on total weight of the zeolite composition. A high water content affects processability in a negative way. Moreover, as water does not add functionality towards tanning a higher water content is undesirable; the presence of water increases transport costs. Moreover, the inventors believe that a low water content is essential for a positive tanning result as it improves the zeolite-acid interaction.

The zeolite composition comprises zeolite. Preferably the zeolite composition comprises at least 34 wt. % zeolite based on total weight of the zeolite composition, more preferably at least 50 wt. % zeolite based on total weight of the zeolite composition, most preferably at least 60 wt. % zeolite based on total weight of the zeolite composition. A higher concentration of zeolite results in a more economical use of the zeolite composition as a single tanning agent as it is the zeolite that interacts with the collagen of the leather and provides the tanning. Preferably the structure of the zeolite is intact in the zeolite composition i.e. analysis demonstrates that no breakdown or disintegration of the zeolite structure is present.

The zeolite composition comprises a first weak acid, a second weak acid and optionally a third weak acid. Preferably the zeolite composition comprises a first weak acid, a second weak acid and a third weak acid. Preferably the amount of the first weak acid is in the range from 2 wt. % to 35 wt. %, more preferably in the range from 5 wt. % to 25 wt. %, even more preferably in the range from 7.5 wt. % to 20 wt. % based on total weight of the zeolite composition. Preferably the amount of the second weak acid is in the range from 2 wt. % to 25 wt. %, more preferably in the range from 5 wt. % to 20 wt. %, most preferably in the range from 10 wt. % to 15 wt. % based on total weight of the zeolite composition. Preferably the amount of the third weak acid, when present, is in the range from 2 wt. % to 25 wt. %, preferably in the range from 5 wt. % to 20 wt. % most preferably in the range from 10 wt. % to 15 wt. % based on total weight of the zeolite composition.

Preferably the amount of the first weak acid is in the range from 2 wt. % to 35 wt. %, more preferably in the range from 5 wt. % to 25 wt. %, even more preferably in the range from 7.5 wt. % to 20 wt. % based on total weight of the zeolite composition and preferably the amount of the second weak acid is in the range from 2 wt. % to 25 wt. %, more preferably in the range from 5 wt. % to 20 wt. %, most preferably in the range from 10 wt. % to 15 wt. % based on total weight of the zeolite composition and preferably the amount of the third weak acid, when present, is in the range from 2 wt. % to 25 wt. %, preferably in the range from 5 wt. % to 20 wt. % most preferably in the range from 10 wt. % to 15 wt. % based on total weight of the zeolite composition.

Preferably the zeolite composition does not comprise tanning salts, more preferably the zeolite composition does not comprise tanning salts, synthetic tanning agents or vegetable tanning agents.

Preferably the zeolite composition comprises less than 20 wt. % of tanning salts based on total weight of the zeolite composition, more preferably less than 10 wt. %, even more preferably less than 5 wt. %; more preferably the zeolite composition comprises less than 20 wt. % of the total of tanning salts, synthetic tanning agents and vegetable tanning agents based on total weight of the zeolite composition, more preferably less than 10 wt. %, even more preferably less than 5 wt. %. Preferably the zeolite composition comprises less than 5 wt. % aluminum sulfate based on total weight of the zeolite composition, most preferably the zeolite composition does not comprise aluminum sulfate.

Preferably the zeolite composition is a powder.

Manufacturing Method of the Zeolite Composition Zeolite is a powder. In the method for preparing the zeolite composition the zeolite is mixed with two or more weak acids. Depending on the aggregation state of the weak acids a manufacturing method needs to be selected.

In case the first weak acid, the second weak acid and the third weak acid, when present, are solid at 20° C., mixing of powders is concerned. Technology for mixing of powders is common in the art. In some cases commonly known measures might be needed to remove heat, as the zeolite powder may interact to some extent with the weak acid powders. Therefore, in case the first weak acid, the second weak acid and the third weak acid, when present, are solid at 20° C., in the method for preparing the zeolite composition the temperature of the mixture during mixing is kept below 100° C., preferably below 90° C., most preferably below 60° C. In case all of the weak acids are solid the order of mixing the different components is of no particular interest.

In case any one of the first weak acid, the second weak acid or the third weak acid, when present, is liquid at 20° C., combining the zeolite and the liquid weak acid or acids may generate considerable heat which may affect product structure of the zeolite composition. Moreover combining a liquid weak acid with a solid weak acid, thus liquid at 20° C. and solid at 20° C., may cause lumping which will lead to poor handling properties for further mixing with zeolite and to undesirable inhomogeneity. Therefore in case any one of the first weak acid, the second weak acid or the third weak acid, when present, is liquid at 20° C., in the method for preparing the zeolite composition first the liquid weak acid or the liquid weak acids is or are mixed with the zeolite and only afterwards further solid weak acids are mixed with the mixture obtained. Mixing of powders and liquids is common in the art. Mixing of zeolite and a liquid weak acid is known from WO 2013/045764 A1.

In case any one of the first weak acid, the second weak acid or the third weak acid, when present, is liquid at 20° C., in the method for preparing the zeolite composition the temperature of the mixture during mixing is kept below 100° C., preferably below 90° C., most preferably below 60° C.

In the method for preparing the zeolite, preferably the mixing takes place in a closed vessel and for example a cooling jacket is used to cool the mixture. In one embodiment of the method for preparing the zeolite, in case any one of the first weak acid, the second weak acid or the third weak acid, when present, is liquid at 20° C., the weak acid which is liquid at 20° C., or the weak acids which are liquid at 20° C. is or are provided continuously over a time period of at least 10 minutes whilst carrying out step ii). Method for producing leather

Producing leather is well known in the art. In general for producing leather hides are firstly pretreated and subsequently tanned. Commonly the last pretreatment step before tanning is pickling of the hides in a pickle liquid. In most cases the tanning step is followed by one or more post-tanning steps to further tailor the leather properties.

In one embodiment the invention concerns a method for producing leather comprising a tanning step wherein a hide is contacted with a tanning liquid comprising the zeolite composition of the invention and the concentration of the zeolite composition is in the range from 1 wt. % to 15 wt. % based on weight of the hide, preferably the concentration of the zeolite composition is in the range from 3 wt. % to 10 wt. % based on weight of the hide, most preferably the concentration of the zeolite composition is in the range from 4 wt. % to 8 wt. % based on weight of the hide.

In the context of the invention, the weight of the hide is the weight of the limed hide.

Preferably contacting the hide with a tanning liquid comprising the zeolite composition of the invention is carried out for a time period that ranges from 10 to 1500 minutes, more preferably from 50 to 500 minutes, even more preferably from 100 to 300 minutes. Preferably contacting the hide with a tanning liquid comprising the zeolite composition of the invention is carried out at a temperature that ranges from 10° C. to 95° C., preferably from 15° C. to 75° C., more preferably from 20° C. to 55° C. Preferably the concentration of tanning liquid is 100 wt. % or less based on weight of the hide, more preferably 50 wt. % or less based on weight of the hide, even more preferably 35 wt. % or less based on weight of the hide.

A low concentration of the tanning liquid improves tanning efficiency and keeps environmental impact low.

As is common in the art before tanning the hides are pickled. Pickling makes the fibers of the hides more receptive to tanning. Preferably in the method for producing leather the hides are pickled before tanning wherein pickling is contacting the hide with a pickling liquid comprising one or more acids and salt.

Preferably the concentration of pickling liquid is 100 wt. % or less based on weight of the hide, more preferably 50 wt. % or less based on weight of the hide, even more preferably 35 wt. % or less based on weight of the hide.

Preferably the pickling liquid comprises organic acids. Organic acids are necessary for good quality of leather. Preferably the concentration of organic acid in the pickling liquid is in the range from 1 wt. % to 5 wt. % based on weight of the hide, more preferably in the range from 2 wt. % to 3 wt. % based on weight of the hide, most preferably in the range from 2.25 wt. % to 2.75 wt. % based on weight of the hide. Preferably the organic acid in the pickling liquid is one or more selected from the group consisting of formic acid, acetic acid and oxalic acid. Salt is present is the pickling liquid for balancing the ionic strength. The pickling liquid preferably comprises in the range from 1 wt. % to 10 wt. % salt based on weight of the hide, more preferably in the range from 4 wt. % to 8 wt. % salt based on weight of the hide. Preferably the initial pH of the pickling liquid is below 3.5, more preferably below 3, most preferably below 2.8. The initial pH of the pickling liquid is the pH of the liquid just before the tanning agent is added to the pickling liquid comprising the hides.

Preferably in the method for producing leather the tanning liquid is obtained by adding the zeolite composition of the invention to the pickling liquid comprising the hides.

As is common in the art near the end of the tanning step, the tanning liquid including the hides is brought to a higher pH. In this step the zeolite is activated to interact with the collagen of the hide. Preferably in the method for producing leather, at the end of the tanning step the pH of the tanning liquid comprising the hides is increased, preferably to a pH between 4.0 and 6.0, more preferably to a pH between 4.5 and 5.5 most preferably to a pH between 4.8 and 5.3. Preferably the pH is increased by adding one or more basic agents selected from the group consisting of sodium hydroxide, sodium bicarbonate, sodium carbonate, soda ash, magnesium oxide, magnesium carbonate, dolomite and potassium hydroxide. Preferably the basic agent is added at different moments in time, preferably wherein the moments in time are at least 5 minutes apart. Preferably the basic agent is added in an total amount of more than 1 wt. % based on weight of hide added, more preferable 2 wt. %.

Leather

In one embodiment the invention concerns leather obtained by the method for producing leather comprising a tanning step wherein a hide is contacted with a tanning liquid comprising the zeolite composition of the invention and the concentration of the zeolite composition is in the range from 1 wt. % to 15 wt. % based on weight of the hide. The invention furthermore concerns leather.

The leather of the invention can be characterized in several ways. The shrinkage temperature of leather or shrinkage temperature (Ts) can be determined according to ASTM D6076-08 and represents the temperature at which a thoroughly wetted leather specimen experiences shrinkage. The shrinkage temperature represents the hydrothermal stability of leather and has developed into an industrial standard for quality control of tanned leather. Preferably the leather of the invention has a shrinkage temperature above 60° C., more preferably above 70° C. Preferably leather of the invention has a shrinkage temperature below 100° C., more preferably below 90° C. High shrinkage temperatures are typical for chrome tanned leather.

The leather of the invention also has a surface charge and isoelectric point (pl). The isoelectric point can be determined as known in the art. A method to determine the isoelectric point is described in Wang et al. (JALCA, Vol. 112, 2017, p224), wherein zeta-potential of the leather was measured at different pH values and the pl was considered the pH at which the zeta-potential was zero. Preferably the isoelectric point of the leather is determined by measuring the zeta-potential of the leather at different pH values, wherein the isoelectric point is the pH value at which the zeta-potential is zero. The pl of leather depends on the type of tanning agent. Metal salt tanned leather has an isoelectric point of above 6.5, since the metal interacts through a cationic association with the leather (positively charged metal ions interact with negatively charged collagen). Synthetic or vegetable tanned leather has an isoelectric point below 5 since the active groups of the synthetic or vegetable tanning agent interacts through a anionic association with the leather (negatively charged active groups interact with positively charged collagen). The inventors now found that by tanning with the zeolite composition of the invention a leather can be obtained that has an isoelectric point below 5. Preferably the leather of the invention has an isoelectric point in the range from 3 to 5, more preferably in the range from 3.5 to 4.5.

Tanning Agent in the Leather

The leather of the invention comprises both the elements aluminum (Al) and silicon (Si). Both aluminum and silicon are evenly distributed in the leather of the invention. Preferably the leather comprises more than 0.3 wt. % aluminum based on dry weight of the leather, more preferably more than 0.5 wt. % based on dry weight of the leather, even more preferably more than 1 wt. % based on dry weight of the leather. Preferably the leather comprises more than 0.3 wt. % silicon based on dry weight of the leather, more preferably more than 0.5 wt. % based on dry weight of the leather, even more preferably more than 1 wt. % based on dry weight of the leather. The amount of the aluminum can be determined by the method content of mineral tanning agent in leather after digestion ISO 17072-2:2019. For silicon the amount can be based on a modification of the ISO 17072-2:2019 method or on relative intensities of aluminum and silicon in SEM-EDX analyses. Preferably the amount of aluminum (Al) based on dry weight of the leather is determined according to ISO 17072-2:2019. For this method, the leather is dried before analysis. The dry weight of the leather referred to for the aluminum and silicon concentration is the weight of the leather as dried according to ISO 17072-2:2019.

In producing leather, an even distribution of the tanning agent is sought. For tanning with a zeolite composition as the tanning agent, it is believed after tanning the zeolite taken up by the leather is not intact but also is not degraded to its elements; it is believed the zeolite is present the leather in a form of a network. For tanning with a zeolite the even distribution may be established by measuring the distribution of aluminum and silicon in the leather. Preferably for the current invention the leather has an even distribution of the zeolite composition, or in other words, preferably aluminum and silicon are evenly distributed in the leather. An even distribution is important as both the appearance as the physical and chemical stability and properties are dependent on the even distribution. The even distribution is known in the art as fully penetrated and can be determined by tests known in the art. Penetration refers both to the distribution of the tanning agent over the surface of the leather and to the distribution of the tanning agent perpendicular to the surface of the leather. The distribution over the surface is established by sensory inspection: by checking if there are no substantial differences in color and/or feel of the leather over the surface. Good penetration or full penetration is effectuated when the tanning agent is evenly distributed, so when the tanning agent has a uniform distribution over the surface of the leather and perpendicular to the surface of the leather. For tanning with a zeolite composition as tanning agent a uniform distribution is present when the lowest local concentration of aluminum and/or silicon in the leather is at least 20% of the highest local concentration of aluminum and/or silicon in the leather. Leather that is not fully penetrated may show color difference between different areas at the surface and differences between different areas at the surface in feel and physical-chemical properties. Moreover as typically leather is shaved after tanning, a new surface will be formed that was below the surface before and during tanning. Typically if the penetration in the plane perpendicular to the surface was not sufficient, so if the leather is not fully penetrated, upon shaving burned areas will appear at the newly formed surface.

Preferably the leather has an even distribution of the zeolite composition, wherein even distribution does mean that the leather is fully penetrated.

A method to establish if the leather has an even distribution of the zeolite composition, is to measure the distribution of aluminum and silicon in the leather. The spatial distribution of silicon and aluminum can be determined by SEM-EDX. Through SEM-EDX a (relative) concentration distribution can be measured for aluminum and silicon. A piece of leather can be cut perpendicular to the surface directions, exposing a perpendicular cross-section. The surface of the perpendicular cross section can be scanned with a finely focused electron beam (SEM). The X-rays that are emitted as a result of the excitation with the electron beam can be measured by energy dispersive X-rays spectroscopy (EDX). In this way for each location on the perpendicular cross section the elemental composition can be determined. An intensity curve over the perpendicular cross-section of the piece of leather for aluminum and silicon can be constructed based on this measurement. The intensity is linearly correlated with the (local) concentration.

Leather can be defined by an upside surface (grain side) and a downside surface (flesh side) which run parallel and a perpendicular cross-section that is perpendicular to these surfaces. Preferably for the leather of the invention the concentration of aluminum at the center of the perpendicular cross-section is at least 20%, preferably at least 30% most preferably at least 50% of the concentration at each surface side of the perpendicular cross-section and/or wherein for the leather of the invention the concentration of silicon at the center of the perpendicular cross-section is at least 20%, preferably at least 30% most preferably at least 50% of the concentration at each surface side of the perpendicular cross-section. Preferably the perpendicular cross-section has a length of at least 0.5 millimeter, more preferably at least 1 millimeter, most preferably at least 2 millimeter.

Compared to leather obtained by other ways of tanning such as tanning with a combination of zeolite and an aluminum salt as tanning agents the ratio of silicon to aluminum is constant for leather of the current invention. A constant ratio guarantees a surface coverage and related surface charge that is similar throughout the whole leather, which is beneficial for further processing of the leather and for a uniform leather quality. Preferably the ratio of aluminum to silicon in the center of the perpendicular cross-section of the leather is within 40%, more preferably within 60%, most preferably within 75% of the ratio of aluminum to silicon at each surface side of the perpendicular cross-section.

Solubilization

The tanning interactions are considered to be strong and the tanning agent well fixated when the solubilization values are low in relation to the total content. The solubilization of a leather for specific mineral elements can be determined by the industry standard method, ‘Determination of soluble mineral tanning agents in leather’ ISO 17072-1:2019. The better the uptake of the tanning agent, the higher the content of the leather, and the better the tanning interactions, the lower the soluble mineral tanning agents. The soluble mineral tanning agent is taken as a percentage of the total content of the mineral tanning agent in the leather, per specific metal element for the tanned leathers. Preferably the soluble mineral tanning agent relative to the total tanning agent in the leather for Si is below 5 wt. %, preferably below 2 wt. %, more preferably below 1 wt. %. Preferably the soluble mineral tanning agent relative to the total tanning agent in the leather for Al is below 5 wt. %, preferably below 2 wt. %, more preferably below 1 wt. %.

Considering that the zeolite composition provides excellent tanning results, no other tanning agents need to be employed and the leather of the invention does not comprise other tanning agents. Preferably the leather of the invention comprises no chromium, more preferably the leather of the invention comprises no chromium, titanium and zirconium, even more preferably the leather of the invention does not comprise chromium, titanium, zirconium and synthetic tanning agents, most preferably the leather of the invention does not comprise chromium, titanium, zirconium, synthetic tanning agents and vegetable tanning agents.

### EXAMPLES

### Example 1—Leather Tanning with a Single Tanning Agent Comprising Zeolite and a Weak Acid

Preparation

Single tanning agents were prepared by mixing zeolite powder (having a water content of less than 20 wt. % on total weight of the zeolite powder) and a weak acid. For all single tanning agents the zeolite employed was A-type zeolite.

In case the weak acid was liquid at room temperature, the single tanning agent was prepared according to the method of WO 2013/045764 A1 (example 2). In short, the concentrated liquid weak acid was slowly and continuously added to the zeolite while mixing, using a dynamic mixer. The temperature was kept below 85° C. by the mixing and by external cooling. A powder was obtained.

In case the weak acid was solid, zeolite and the weak acid were dry mixed. Some heat generation occurred while dry blending, but temperatures did not exceed 50° C. and no cooling was required. The single tanning agents prepared are listed in table 2. A reference without a weak acid was also tested (variant 1A). Each weak acid was added to the zeolite in concentrated form, having a water content of less than 20 wt. %. For each single tanning agent, the zeolite content was 65 wt. % on total weight and the weak acid content was 35 wt. % on total weight. The water content of the final single tanning agent was in all cases below 20 wt. % on total weight of the single tanning agent. About 12 kg of hide was tanned for each example.

Tanning

Unhaired bull hides are limed, delimed, and bated according to industry standard methods, are washed before the pickling and tanning of the hides is performed. The recipe of table 1 is followed. In this table, the weight percentages of the components for the pickling and tanning are relative to the limed hides weight. Between brackets is the dilution factor of the component that is added. The components are diluted with water before addition. The concentration before dilution for sulfuric acid is 98% (wt. % on total), and for formic acid is 85% (wt. % on total). The single tanning agent is added in a concentration as listed in table 1 and 2 (‘tanning agent concentration’). Industry standard is to leave the hides overnight in the pickle. For the zeolite tannage this is also possible. For the variants of example 1-3 overnight pickling was tested and did not affect the results. The hides were left overnight after the final sulfuric acid addition on 5 min rotation per hour. In the morning final adjustment of pH is done if necessary and the single tanning agent is added.

Analysis

The leather samples were organoleptically assessed by an expert panel. The leather was assessed for leather feel wherein hardness (slick, firm, hard, very hard) and fullness (empty, round, full) was established. Moreover, the penetration was assessed; the cuts were visually observed and the surface area of the hides were observed for equal distribution and penetration. Penetration was also observed by SEM-EDX analyses of the cross sections at different positions. The penetration is summarized as Not ok′, ‘Partly’, ‘Complete’, and ‘Empty patches’ when some parts of the hides were not penetrated. Shrinkage temperature was determined by differential scanning calorimetry (DSC), according to ASTM D6076-08 as known in the art. In the art DSC is an accepted method to be used in D6076-08. Uptake was determined based on aluminum. A high uptake is preferred as in that case the single tanning agent is efficient. For the examples the amount of aluminum per dry weight of tanned leather was measured by ICP-MS and multiplied by the total amount of dry tanned leather leading to the amount of aluminum retained. The offered amount of aluminum is calculated based on the amount of single tanning agent added. ICP-MS is performed according to ISO 17072-2:2019.

TABLE 1
Tanning recipe

| | Weight | | Drum | |
|---|---|---|---|---|
| | percentage | | time | |
| Stage | (wt. %) | Component | (min) | pH |
| Pickling | 25 | water | | |
| | 6 | salt | 15 | |
| | 1 | formic acid (1:10) | 20 | |
| | 1.25 | formic acid (1:10) | 20 | |
| | 0.3 | sulfuric acid (1:10) | 60 | |
| | 0.3 | sulfuric acid (1:10) | 30 | 2.5-3.0 |
| Tanning | X | Single tanning agent | 180 | 3.2-4.1 |
| | 0.5 | sodium bicarbonate (1:20) | 20 | |
| | 0.5 | sodium bicarbonate (1:20) | 20 | |
| | 0.5 | sodium bicarbonate (1:20) | 30 | |
| | 0.5 | sodium bicarbonate (1:20) | 30 | |
| | 0.5 | sodium bicarbonate (1:20) | 30 | |
| | 0.5 | sodium bicarbonate (1:20) | 30 | |
| | 0.2 | sodium bicarbonate powder | 120 | 4.2-5.5 |
| Drain | | | | |

For some of the examples the solubilization is determined, according to the industry standard method ‘Determination of soluble mineral tanning agents in leather’ ISO 17072-1:2019. The solubilization relates to the amount of a mineral that can be extracted from the leather after tanning with a tanning agent and wherein the mineral is a mineral of the tanning agent. For the examples the mineral determined was aluminum. The solubilization is taken as a percentage of the total content of the mineral in the leather.

Results

The resulting leather properties are listed in table 2. Zeolite as single tanning agent without addition of an acid gave in all concentrations applied a poor tanning result. Although the zeolite increased the shrinkage temperature, penetration and leather feel were poor. The introduction of a weak acid in the single tanning agent improved feel and penetration somewhat but feel and penetration were still not acceptable. Leather feel could be steered by selection of weak acid. The leather kept its natural color without off-color. A higher amount of the single tanning agent increased the shrinkage temperature but not any other parameter.

TABLE 2
Results for a single tanning agent comprising zeolite and a weak acid.
The tanning agent concentration is based on limed hides weight.

| | | Tanning agent | Shrinkage | | | |
|---|---|---|---|---|---|---|
| | | concentration | temp. | | | Uptake |
| | Weak acid | (wt. %) | (° C.) | Leather feel | Penetration | (%) |
| 1A | — | 3 | 65 | Not ok | Not ok | |
| | | 6 | 68 | Not ok | Partly, empty patches | 22 |
| | | 9 | 75 | Not ok | Partly, empty patches | |
| 1B | Formic acid | 3 | 72 | Hard | Partly | |
| | | 6 | 85 | Hard | Partly | 26 |
| 1C | Adipic acid | 3 | 59 | Very hard | Partly, empty patches | |
| | | 6 | 67 | Very hard | Partly, empty patches | 29 |
| 1D | Citric acid | 3 | 63 | Empty, slick | Empty patches | |
| | | 6 | 68 | Empty, slick | Partly, empty patches | 20 |
| 1E | Sodium bisulfate | 3 | 58 | Not ok | Partly | |
| | | 6 | 65 | Not ok | Partly | 27 |
| 1F | Oxalic acid | 3 | 68 | Firm | Partly | |
| | | 6 | 80 | | Partly | 36 |
| 1G | Phtalic acid | 3 | 66 | Firm | Partly | |
| | | 6 | 90 | Firm | Partly | — |
| 1H | Salycylic acid | 6 | 72 | Not ok | Partly | — |
| 1I | Maleic acid | 6 | 82 | Firm | Partly | 22 |
| 1J | Tartaric acid | 6 | 80 | Firm | Partly | 25 |

### Example 2—Leather Tanning with a Single Tanning Agent Comprising Zeolite, a First Weak Acid and a Second Weak Acid

Zeolite and a first weak acid were mixed according example 1. The mixture obtained was mixed together with a second weak acid to obtain the single tanning agent. The combinations tested are listed in table 3. Each weak acid was added in concentrated form, having a water content of less than 20 wt. %. For each single tanning agent, the zeolite content was 70 wt. % on total weight of the single tanning agent, the first weak acid content was 15 wt. % on total weight of the single tanning agent and the second weak acid content was 15 wt. % on total weight of the single tanning agent. The water concentration of the final single tanning agent was in all cases was below 20 wt. % on total weight of the single tanning agent. The leather was tanned according to example 1 (table 1). The amount of the single tanning agent added during tanning is in table 3.

Assessment of the tanning efficiency and the leather obtained was according to example 1, the results are listed in table 3. In general the tanning performance improved with a single tanning agent comprising two weak acids compared to a single tanning agent comprising one weak acid. Penetration improved for variants 2F-2K and a wider range of textural attributes could be obtained. For combinations (2D-2K) the uptake improved. The shrinkage temperature for example 2 is in the same range as for example 1. The leather kept its natural color without off-color.

TABLE 3
Results for a single tanning agent comprising zeolite a first weak acid and a second
weak acid. The tanning agent concentration is based on limed hides weight.

| | | | Tanning agent | Shrinkage | | | | |
|---|---|---|---|---|---|---|---|---|
| | | | concentration | temperature | | | Uptake | Solubilization |
| | Weak acid 1 | Weak acid 2 | (wt. %) | (° C.) | Leather feel | Penetration | (%) | (%) |
| 2A | Formic acid | Citric acid | 6 | 76 | Firm, slick | Partly | 26 | |
| 2B | Citric acid | Oxalic acid | 6 | 67 | Empty, hard | Partly | 26 | 7.8 |
| 2C | Citric acid | Sodium bisulfate | 6 | 69 | Firm, slick | Partly | 27 | |
| 2D | Phtalic acid | Sodium bisulfate | 6 | 78 | Smooth | Partly | 46 | |
| 2E | Succinic acid | Sodium bisulfate | 6 | 68 | Hard | Partly | 52 | |
| 2F | Formic acid | Tartaric acid | 6 | 75 | Firm, hard | Complete | 70 | 0.3 |
| 2G | Formic acid | Oxalic acid | 6 | 72 | Firm, hard | Complete | 67 | 1.0 |
| 2H | Oxalic acid | Sodium bisulfate | 6 | 74 | Smooth | Complete | 43 | |
| 2I | Sodium bisulfate | Oxalic acid | 6 | 72 | Smooth | Complete | 41 | |
| 2J | Formic acid | Sodium bisulfate | 6 | 77 | Firm, hard | Complete | 53 | |
| 2K | Formic acid | Gallic acid | 6 | 68 | Smooth | Complete | 65 | 3.7 |

### Example 3—Leather Tanning with a Single Tanning Agent Comprising Zeolite, a First Weak Acid, a Second Weak Acid and a Third Weak Acid

Zeolite and a first weak acid were mixed according example 1. The mixture obtained was mixed together with a second weak acid and a third weak acid to obtain the single tanning agent. The combinations tested are listed in table 4. Each weak acid was added to the zeolite in concentrated form, having a water content of less than 20 wt. %. For each single tanning agent, the zeolite content was 60 wt. % on total weight of the single tanning agent, the first weak acid content was 10 wt. % on total weight of the single tanning agent, the second weak acid content was 15 wt. % on total weight of the single tanning agent and the third weak acid content was 15 wt. % on total weight of the single tanning agent. The water concentration of the final single tanning agent was in all cases was below 20 wt. % on total weight of the single tanning agent. The leather was tanned according to example 1 (table 1). The amount of the single tanning agent added during tanning is in table 4. Different to examples 1 and 2 the average total weight of the hides in each trials is about 65 kg.

TABLE 4
Results for a single tanning agent comprising zeolite, a first weak acid, a second weak acid
and a third weak acid. The tanning agent concentration is based on limed hides weight.

| | | | | Tanning agent | Shrinkage | | | | |
|---|---|---|---|---|---|---|---|---|---|
| | | | | concentration | temp. | | | Uptake | Solubilization |
| | Weak acid 1 | Weak acid 2 | Weak acid 3 | (wt. %) | (° C.) | Leather feel | Penetration | (%) | (%) |
| 3A | Formic acid | Citric acid | Sodium bisulfate | 6 | 72 | Smooth, slick | Complete | 44 | 0.5 |
| 3B | Formic acid | Tartaric acid | Sodium bisulfate | 6 | 75 | Smooth, hard | Complete | 71 | 0.3 |
| 3C | Formic acid | Oxalic acid | Sodium bisulfate | 6 | 72 | Smooth, soft | Complete | 76 | 0.2 |
| 3D | Formic acid | Citric acid | Oxalic acid | 6 | 67 | Hard | Complete | 56 | 4 |
| 3E | Oxalic acid | Gallic acid | Tartaric acid | 6 | 75 | Hard | Complete | 51 | 2 |
| 3F | Oxalic acid | Tartaric acid | Sodium bisulfate | 6 | 72 | Hard | Complete | 61 | 0.1 |
| 3G | Formic acid | Oxalic acid | Gallic acid | 6 | 67 | Hard | Complete | 65 | 4 |

Assessment of the leather obtained was according to example 1, the results are listed in table 4. In general the tanning performance improved with a single tanning agent comprising three acids compared to a single tanning agent comprising one or two acid. Penetration and uptake improved and a wider range of textural attributes could be obtained. Moreover the shrinkage temperature increased. The leather kept its natural color without off-color.

Surprisingly a single tanning agent comprising zeolite and three acids delivers an excellent tanning result without addition of any further tanning agent. The single tanning agent provides ease of use as it can be added as a powder. Moreover the known disadvantages of conventional tanning agents, such as toxicity (e.g. chromium and aluminum salts, aldehydes), long penetration times (natural tannins and tannin extracts), solubilization (aluminum, zirconium titanium salts), limited leather article applications (aluminum, zirconium titanium salts), consistent leather quality (aluminum, zirconium titanium salts), limited colors (natural tannins and tannin extracts) and discoloring of the leather (e.g. chromium salts, iron salts) can be prevented.

### Example 4—Leather Tanning with a Single Tanning Agent Comprising a Weak Inorganic Acid Salt Comprising Aluminum

As an addition to example 3 leather is tanned analogue to the method of example 3 with a single tanning agent comprising three weak acids wherein one acid is a weak inorganic acid salt comprising aluminum. In comparison to example 3 MgO instead of sodium bicarbonate was used to increase the pH at the end of the tanning, MgO is known to improve the uptake compared to sodium bicarbonate. The single tanning agent is prepared according to example 3. The results are listed in table 5. The leather feel and penetration of this single tanning agent is poor. Replacing part of the weak acids of the single tanning agent of example 2a (a single tanning agent comprising zeolite, formic acid and citric acid) by aluminum sulfate lowers the shrinkage temperature and worsens leather feel, moreover uptake is hardly improved even whilst MgO was used to increase the pH.

TABLE 5
Results for a single tanning agent comprising zeolite, a first weak acid, a second weak acid and a third weak acid, wherein one of
the acids is a weak inorganic acid salt with aluminum as cation. The tanning agent concentration is based on limed hides weight.

| | | | | Tanning agent | Shrinkage | | | | |
|---|---|---|---|---|---|---|---|---|---|
| | | | | concentration | temp. | | | Uptake | Solubilization |
| | Weak acid 1 | Weak acid 2 | Weak acid 3 | (wt. %) | (° C.) | Leather feel | Penetration | (%) | (%) |
| 4A | Formic acid | Citric acid | Aluminum sulfate | 6 | 64 | Hard, empty | Empty pockets | 45 | |

### Example 5—Large Scale Application of the Single Tanning Agent

A zeolite composition according to composition 3C in table 4 was applied as a single tanning agent in a large scale test. The zeolite composition was prepared according to example 3.

Tanning

Unhaired bull hides are limed, delimed, and bated according to industry standard methods, are washed before the pickling and tanning of the hides is performed. The recipe of table 6 is followed. In this table, the weight percentages of the components for the pickling and tanning are relative to the limed hides weight. Between brackets is the dilution factor of the component that is added. The components are diluted with water before addition. The concentration before dilution for sulfuric acid is 98% (wt. % on total), and for formic acid is 85% (wt. % on total). The single tanning agent is added in a concentration as listed in table 6 ad 7 (tanning agent concentration). The large scale trial is performed with a total weight of the hides of 550 kg which is a typical quantity that is applied in large scale industrial leather tanning. The leather was tanned according to table below.

TABLE 6
Large scale tanning recipe

| | Weight | | Drum | |
|---|---|---|---|---|
| | percentage | | time | |
| Stage | (wt. %) | Component | (min) | pH |
| Pickling | 25 | water | | |
| | 5 | salt | | |
| | 0.3 | Preservative | 15 | |
| | 1.2 | formic acid (1:10) | 20 | |
| | 1 | formic acid (1:10) | 20 | 3.21 |
| | 0.45 | sulfuric acid (1:10) | 60 | |
| | 0.45 | sulfuric acid (1:10) | 30 | 2.67 |
| Tanning | 7 | Single tanning agent | 300 | 3.64 |
| | 0.25 | sodium ash (1:10) | 20 | |
| | 0.25 | sodium ash (1:10) | 20 | |
| | 0.2 | sodium ash (1:10) | 30 | |
| | 0.3 | sodium ash (1:10) | 30 | |
| | 0.3 | sodium ash (1:10) | 30 | |
| | 0.3 | sodium ash (1:10) | 30 | |
| | 0.3 | sodium ash (1:10) | 120 | 5.01 |
| Rotate | | | Overnight | 4.61 |
| Drain | | | | |
| Wash | 100 | Water | | |

In table 7 the results of the large scale test are listed. The large scale experiment demonstrates an excellent tanning result with complete penetration, very high uptake and good shrinkage temperature. The aluminum content of table 7 was measured by ICP-MS according to ISO 17072-2:2019.

Furthermore a piece of tanned leather obtained by the large scale test was analyzed by SEM-EDX. Through SEM-EDX a (relative) concentration distribution was measured for aluminum and silicon. The piece of leather was cut perpendicular to the surface direction, exposing a perpendicular cross-section. The surface of the perpendicular cross section was scanned with a finely focused electron beam (SEM). The X-rays that are emitted as a result of the excitation with the electron beam was measured by energy dispersive X-rays spectroscopy (EDX). Analysis was done with a Tescan Vega 3 SEM fitted with an Oxford Instruments X-Max 80 X-ray source, the result were analysed with corresponding software provided by the suppliers of the equipment.

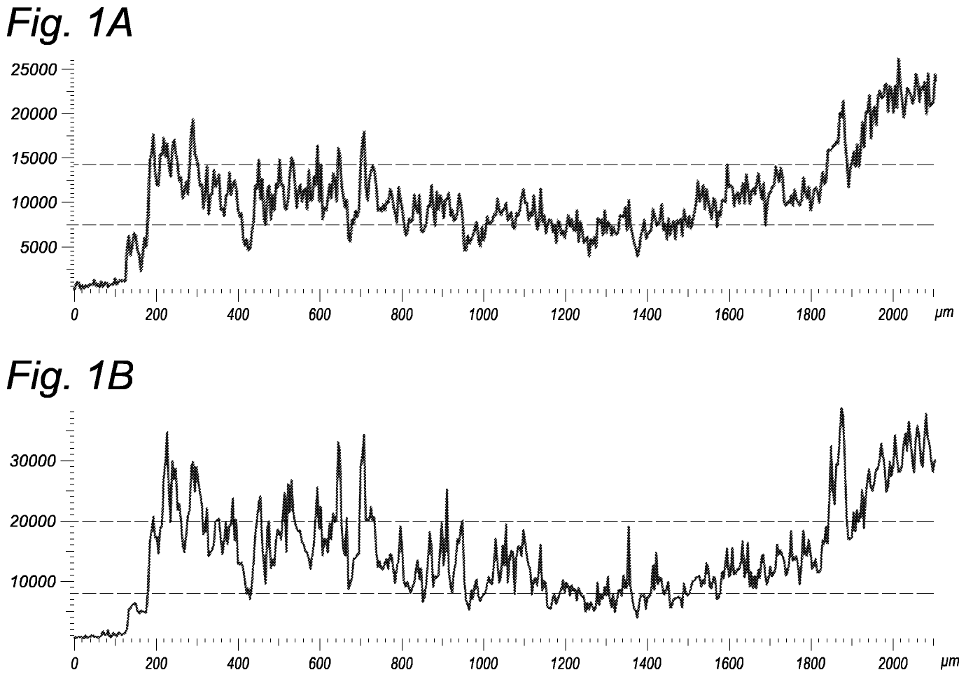

In this way for each location on the perpendicular cross section the elemental composition can be determined. An intensity curve over the perpendicular cross-section of the piece of leather for aluminum and silicon was constructed based on this measurement (FIGS. 1A and 1B). The left side (around 200 μm) is the flesh side, the right side (around 1800 μm) the grain side. The intensity is linearly correlated with concentration. The upper dashed line is the concentration/intensity at the surface, the lower dashed line is the concentration/intensity at the center of the perpendicular cross section of the piece of leather. The increase of intensity from about 1900 μm and higher is due to an anomaly related to tilting of the image, leading to higher intensities due to measuring increased measuring area.

FIGS. 1A and 1B demonstrate the single tanning agent has penetrated fully throughout the leather. Leather normally does not comprise silicon and aluminum and the figures demonstrate both the silicon and the aluminum coming from the single tanning agent are present throughout the perpendicular cross section. The concentration of aluminum at the center of the perpendicular cross section is about 50% of the concentration at the surface (7000/14000=50%). The concentration of silicon at the center of the perpendicular cross section is about 40% of the concentration at the surface (8000/20000=40%). The intensity ratio of aluminum to silicon is constant over the cross section.

The isoelectric point of the leather is 3.8. The isoelectric point was determined on a Electrokinetic Analyzer for Solid Surface Analysis (SurPass™, Anton Paar). The leather sample is dried on air, split and cut to a diameter of 12.7 mm and fitted on a gap cell. The start solution comprises 0.01 M KCl adjusted with KOH to pH 9.8 and during the experiment titrated with 0.01 M HCl. During the experiment the pressure gradient and the electrical current are measured to allow for the calculation of the zeta potential.

TABLE 7
Results for large scale tanning with a single tanning agent comprising zeolite, a first weak acid, a second weak acid
and a third weak acid. The tanning agent concentration is based on limed hides weight. The aluminum and silicon concentration
concern the amount in the tanned leather (weight aluminum/silicon on total weight of the leather).

| | | | | Tanning agent | Shrinkage | | | Al | Si- | |
|---|---|---|---|---|---|---|---|---|---|---|
| | | | | concentration | temp. | | Uptake | content | content | Solubilization |
| | Weak acid 1 | Weak acid 2 | Weak acid 3 | (wt. %) | (° C.) | Penetration | (%) | (wt. %) | (wt. %) | (%) |
| 7A | Formic acid | Oxalic acid | Sodium bisulfate | 7 | 74.9 | Complete | 87 | 2.2 | 1.9 | 0.6 |

1. A zeolite composition suitable as single tanning agent comprising zeolite, a first weak acid, a second weak acid and optionally a third weak acid wherein the first, the second and the third weak acid are different acids, the amount of zeolite is at least 34 wt. %, based on total weight of the zeolite composition and the amount of water is less than 25 wt. % based on total weight of the zeolite composition, wherein the first weak acid, the second weak acid and the third weak acid when present are selected from the group consisting of an organic acid, a salt of an organic acid comprising a cation, a weak inorganic acid and a weak inorganic acid salt comprising a cation wherein the cation is selected from the group consisting of sodium, potassium, ammonium, calcium and magnesium.

2. The zeolite composition according to claim 1, wherein the amount of the first weak acid is in the range from 2 wt. % to 35 wt. % based on total weight of the zeolite composition and the amount of the second weak acid is in the range from 2 wt. % to 25 wt. % based on total weight of the zeolite composition and wherein the amount of the third weak acid, when present, is in the range from 2 wt. % to 25 wt. % based on total weight of the zeolite composition.

3. The zeolite composition according to claim 1, wherein
the second weak acid is a carboxylic acid, a cation organic sulfonate or a weak inorganic acid salt comprising a cation wherein the cation is selected from the group consisting of sodium, potassium, ammonium, calcium and magnesium, and
the third weak acid, when present, is a polycarboxylic acid, a cation organic sulfonate or a weak inorganic acid salt comprising a cation wherein the cation is selected from the group consisting of sodium, potassium, ammonium, calcium and magnesium.

4. The zeolite composition according to claim 1, wherein the first weak acid is a dicarboxylic acid and the second weak acid is a monocarboxylic acid, a dicarboxylic acid or a weak inorganic acid salt comprising a cation, wherein the cation is selected from the group consisting of sodium, potassium, ammonium, calcium and magnesium.

5. The zeolite composition according to claim 1 wherein the third weak acid is present.

6. The zeolite composition according to claim 1, wherein the third weak acid is present and the first weak acid, the second weak acid and the third weak acid are selected from the group consisting of formic acid, citric acid, oxalic acid, tartaric acid, gallic acid and sodium bisulfate; preferably wherein the third weak acid is present and the first weak acid is selected from the group consisting of formic acid and oxalic acid and the second weak acid is selected from the group consisting of citric acid, tartaric acid, gallic acid and oxalic acid and the third weak acid is selected from the group consisting of sodium bisulfate, tartaric acid, gallic acid and oxalic acid.

7. The zeolite composition according to claim 1, which is a powder.

8. The zeolite composition according to claim 1, which does not comprise a tanning salt, preferably the zeolite composition does not comprise tanning salts, synthetic tanning agents or vegetable tanning agents.

9. A method for preparing the zeolite composition of claim 1, comprising
a) in case the first weak acid, the second weak acid and the third weak acid, when present, are solid at 20° C.
i) mixing the first weak acid, the second weak acid, the zeolite and the third weak acid, when present, while keeping the temperature of the mixture during mixing below 100° C.;
or
b) in case any one of the first weak acid, the second weak acid or the third weak acid, when present, is liquid at 20° C.
ii) mixing the weak acid which is liquid at 20° C., or the weak acids which are liquid at 20° C. with the zeolite while keeping the temperature of the mixture during mixing below 100° C., and
iii) mixing any remnant weak acid or remnant weak acids with the mixture obtained in step ii) while keeping the temperature of the mixture during mixing below 100° C.

10. A zeolite composition suitable as single tanning agent obtained by the method of claim 9.

11. A method for producing leather, comprising a tanning step wherein a hide is contacted with a tanning liquid comprising the zeolite composition of claim 1, and the concentration of the zeolite composition is in the range from 1 wt. % to 15 wt. % based on weight of the hide.

12. The method according to claim 11, wherein no chromium, aluminum, titanium, zirconium and iron salt based tanning agents are contacted with the hide before, during or after the tanning step.

13. The method according to claim 11, further comprising one or more retanning steps, fat liquoring steps, finishing steps or any combination thereof.

14. Leather having
a shrinkage temperature of above 60° C., and
an iso-electric point in the range from 3 to 5, and comprising more than 0.5 wt. % aluminum based on dry weight of the leather and more than 0.5 wt. % silicon based on dry weight of the leather.

15. The leather of claim 14, which comprises an upside surface and a downside surface which run parallel and a perpendicular cross-section that is perpendicular to these surfaces,
wherein at the center of the perpendicular cross-section the concentration of aluminum is at least 30% of the concentration at each surface side of the perpendicular cross-section and/or wherein at the center of the perpendicular cross-section the concentration of silicon is at least 30% of the concentration at each surface side of the perpendicular cross-section.

16. The zeolite composition according to claim 1, wherein the first weak acid and the second weak acid are selected from the group consisting of phtalic acid, succinic acid, formic acid, oxalic acid, tartaric acid, gallic acid and sodium bisulfate; preferably wherein the first weak acid is selected from the group consisting of phtalic acid, succinic acid and oxalic acid and the second weak acid is selected from the group consisting of sodium bisulfate, tartaric acid, gallic acid and oxalic acid.

17. The zeolite composition according to claim 1, wherein the first weak acid and the second weak acid are selected from the group consisting of formic acid, oxalic acid, tartaric acid, gallic acid and sodium bisulfate; preferably wherein the first weak acid is selected from the group consisting of formic acid, sodium bisulphate and oxalic acid and the second weak acid is selected from the group consisting of sodium bisulfate, tartaric acid, gallic acid and oxalic acid.
